(19) United States
(12) Patent Application Publication
(10) Pub. No.: US 2007/0262949 A1
(43) Pub. Date: Nov. 15, 2007

(54) Electrophoretic display with reduction of remnant voltages by selection of characteristics of inter-picture potential differences

(76) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,542

(22) PCT Filed: Jun. 25, 2004
(86) PCT No.: PCT/IB04/51012

§ 371 Date: Dec. 28, 2005

(30) Foreign Application Priority Data
Jul. 3, 2003 (EP) 03101987.0

(51) Int. Cl. G09G 3/34

(52) U.S. Cl. 345/107

(57) ABSTRACT

An electrophoretic display panel (1), comprising a plurality of picture elements (2), an electrophoretic medium (5) having charged particles (6), and first and second electrodes (3,4) associated with each picture element (2) for receiving a potential difference. As the display (1) is addressed, for each picture element (2), the product of voltage and duration of picture voltages is read from a controller (102). After one or more image update periods, there will be a history generated of the total energy seen by each picture element (2). DC balancing is achieved by introducing feedback loop into the controller (102) which attempts to reduce the number stored in the memory (104) to zero, for each picture element (2) by applying one or more high voltage short pulses with a polarity opposite to the number stored in the memory (104).

This invention relates generally to electrophoretic displays in which tiny coloured particles move in a fluid between electrodes.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause it to occupy a position between the electrodes, depending on the value and duration of the applied potential difference, so as to display a picture.

In more detail, an electrophoretic display device is a matrix display with a matrix of pixels which are associated with intersections of crossing data electrodes and select electrodes. A grey level, or level of colourisation of a pixel depends on the time a drive voltage of a particular level is present across the pixel. Dependent on the polarity of the drive voltage, the optical state of the pixel changes from its present optical state continuously towards one of the two limit situations, e.g. one type of all charged particles is near the bottom or near the top of the pixel. Grey scales are obtained by controlling the time the voltage is present across the pixel.

Usually, all of the pixels of the matrix display are selected line by line by supplying appropriate voltages to the select electrodes. The data is supplied in parallel via the data electrodes to the pixels associated with the selected line. The time required to select all the pixels of the matrix display once is called the sub-frame period. A particular pixel either receives a positive drive voltage, a negative drive voltage, or a zero drive voltage during the whole sub-frame period, dependent on the change in optical state required to be effected. A zero drive voltage should be applied to the pixel if no change in optical state is required to be effected.

In general, in order to generate grey scales (or intermediate colour states), a frame period is defined comprising a plurality of sub-frames, and the grey scales of an image can be reproduced by selecting per pixel during how many sub-frames the pixel should receive which drive voltage (positive, zero, or negative). Usually, the sub-frames are all of the same duration, but they can be selected to vary, if desired. In other words, typically grey scales are generated by using a fixed value drive voltage (positive, negative, or zero) and a variable duration of drive periods.

In a display using electrophoretic foil, many insulating layers are present between the ITO-electrodes, which layers become charged as a result of the potential differences. The charge present at the insulating layers is determined by the charge initially present at the insulating layers and the subsequent history of the potential differences. Therefore, the positions of the particles depend not only on the potential differences being applied, but also on the history of the potential differences. As a result, significant image retention can occur, and the pictures subsequently being displayed according to image data differ significantly from the pictures which represent an exact representation of the image data.

As stated above, grey levels in electrophoretic displays are generally created by applying voltage pulses for specified time periods. They are strongly influenced by image history, dwell time, temperature, humidity, lateral inhomogeneity of the electrophoretic foils, etc. In order to consider the complete history, driving schemes based on the transition matrix have been proposed. In such an arrangement, a matrix look-up table (LUT) is required, in which driving signals for a greyscale transition with different image history are predetermined. However, build up of remnant dc voltages after a pixel is driven from one grey level to another is unavoidable because the choice of the driving voltage level is generally based on the requirement for the grey value. The remnant dc voltages, especially after integration after multiple greyscale transitions, may result in severe image retention and shorten the life of the display.

Known methods of reducing image retention use reset pulses supplied to all pixels (between picture voltages). The reset pulses are of the same polarity value as the preceding picture voltage, but of a shorter time duration, and cause the image displayed to become completely white or black after each sub-frame period. Consequently, these reset pulses seriously diminish display performance because the display flashes between black and white.

Non pre-published European patent application PHNL030205EPP, which has been filed as European Patent Application 03100575.4, describes an arrangement in which the reset pulses applied to each pixel between picture voltages are of an opposite polarity to the preceding picture voltage, which reduces the undesired charge accumulation in the pixel, and causes at least part of the charging of the insulators due to the picture voltage to be undone. Therefore, the display panel is subsequently able to display pictures of at least relatively medium quality.

Non pre-published European patent application PHNL021026EPP, which has been filed as European Patent Application 02079282.6, describes an alternative arrangement, in which a DC-balancing circuit is provided to overcome the above-mentioned problems. The DC-balancing circuit includes a controller for determining, in respect of each pixel or relatively small sub-group of pixels, a time-average (of picture voltage) applied thereto, and for adapting the value and/or duration of the picture voltage applied to the respective pixel (or sub-group of pixels) to obtain a time-average value of around zero. This control of the amplitude of the drive voltages and/or the duration of the drive pulses, causes image retention to be reduced, without the need for reset pulses in respect of all of the pixels, and therefore with less disturbing visual effects than in the above-mentioned prior art method.

It is an object of the invention to provide an improved arrangement.

In accordance with the present invention, there is provided a display apparatus comprising:
An electrophoretic medium comprising charged particles in a fluid;
A plurality of picture elements;
A first and second electrode associated with each picture element for receiving a potential difference; and
Drive means arranged to:
   a) supply a sequence of picture potential differences to each of said picture elements, each of said picture potential differences having a picture value and an associated picture duration, the product of which represents a picture energy for enabling the particles to occupy one of the positions for displaying a picture; and
   b) supply one or more inter-picture potential differences between at least two consecutive picture potential differences, said one or more inter-picture potential differences having an inter-picture value and an associated inter-picture duration, the product of which represents an inter-picture energy which is insufficient to substantially change the position of the particles;
      the apparatus further comprising memory means for receiving data representative of the picture energy and inter-picture energy of all potential differences applied to each picture element, and providing a running total thereof for each picture element, the drive means being arranged to select the polarity of said one or more inter-picture potential differences such that the magnitude of said running total for a respective picture element is reduced.

A time interval of, say, around 0.5 s is preferably provided between each inter-picture potential difference applied to a picture element, so as to avoid integration of energies involved in these potential differences, and therefore ensure that they cause little or no optical effect.

In one embodiment of the present invention, the pulse time-period of each inter-picture potential difference may be 2-8 ms, and the maximum voltage available on the drive means, e.g. 15 Volts/−15 Volts, is preferred. The number and polarity of said inter-picture potential differences are preferably stored in the memory means.

Thus, a method and apparatus are proposed for reducing image retention in an electrophoretic display by reducing the remnant dc on the display. The energy involved in a single high voltage short pulse (i.e. inter-picture potential difference), expressed as Voltage x Time, is insufficient to move the particles over any significant distance, so there is little or no optical state change. A time interval of, say, 0.5 s between each pulse is highly beneficial to avoid the integration of energies involved in these pulses (so as to avoid the visible optical effect). Memory means are provided in the apparatus to store data representative of the remnant dc voltages from previous image transitions so that the number and voltage sign of these short pulses can be selected to balance these dc voltages.

As a result of the present invention, dc-balanced driving can be realised, which leads to more accurate grey levels with reduced image retention.

In one embodiment of the invention, one or more of the inter-picture potential differences have an inter-picture used in the display. The application of a sufficiently low inter-picture potential difference means that this potential difference can be applied for as long as is required without substantially changing the position of the particles in the electrophoretic medium.

These and other aspects of the present invention will be apparent from, and elucidated with reference to, the embodiment described hereinafter.

An embodiment of the present invention will now be described by way of example only, and with reference to the accompanying drawings, in which:

FIG. 1 is a schematic front view of a display panel according to an exemplary embodiment of the present invention;

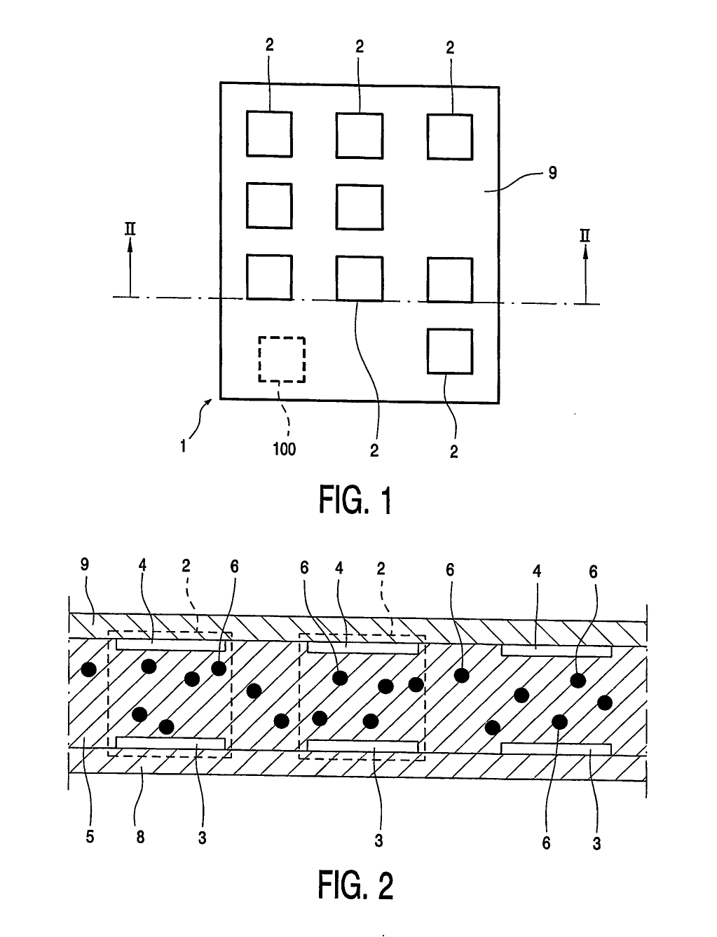

FIG. 2 is a schematic cross-sectional view along II-II of FIG. 1;

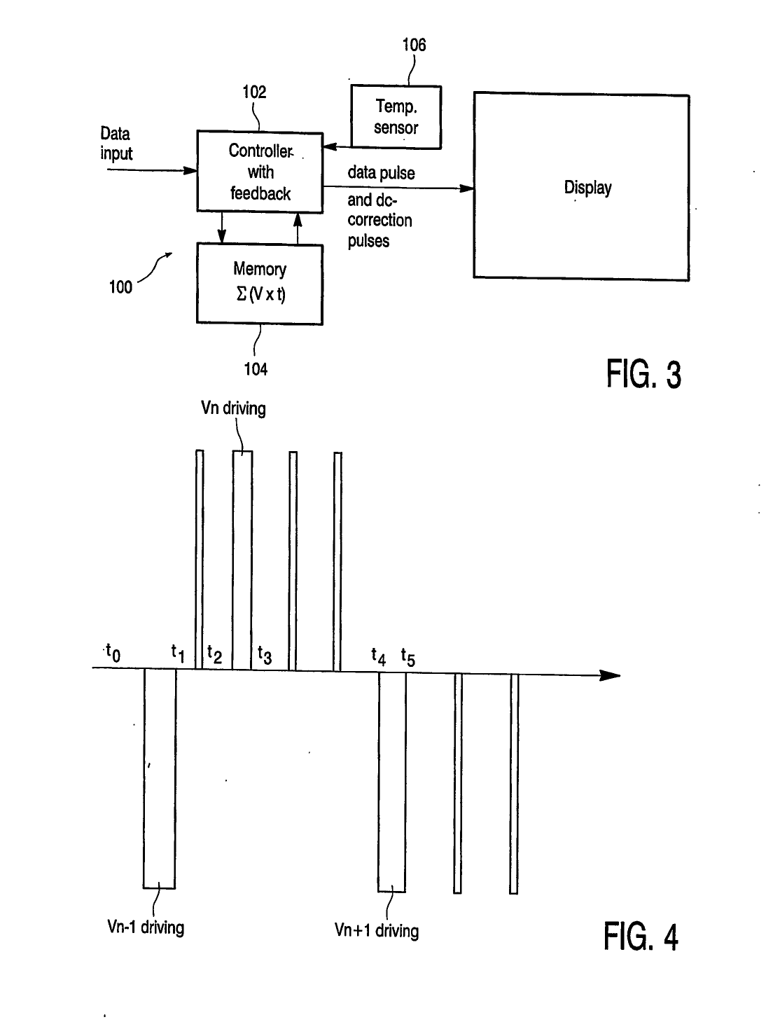

FIG. 3 is a schematic block diagram of elements of apparatus according to an exemplary embodiment of the invention;

FIG. 4 illustrates graphically a potential difference as a function of time for a picture element of an exemplary embodiment of the present invention.

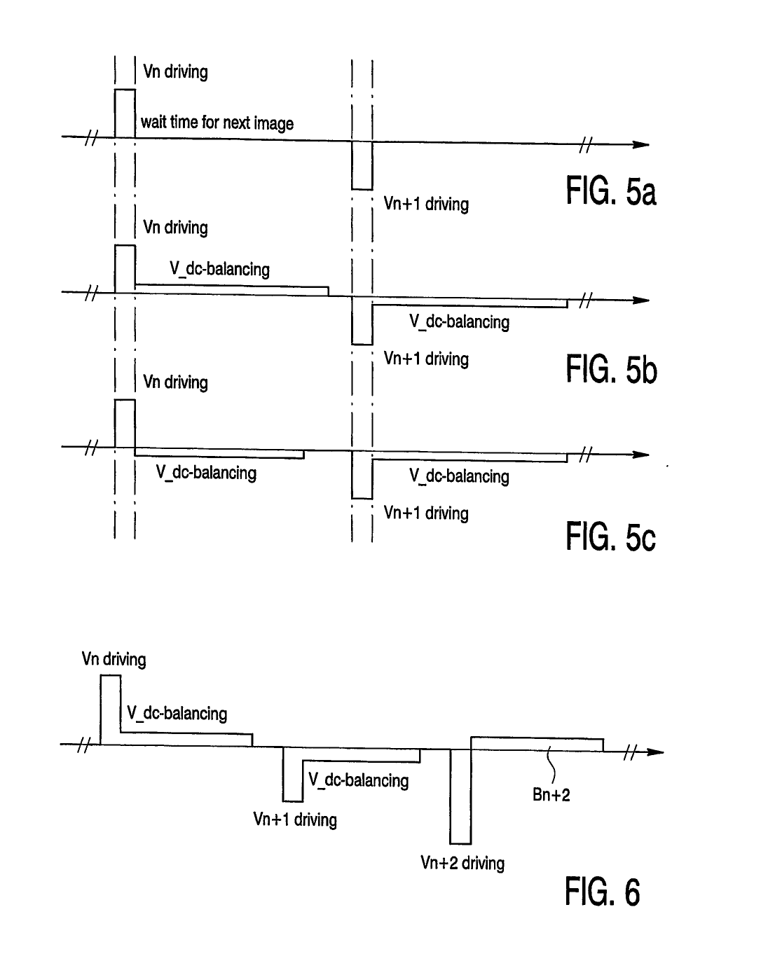

FIG. 5(a) illustrates part of a typical random greyscale transition sequence using a voltage modulated transition matrix, (b) illustrates the same random sequence as (a), but using low voltage pulses with an amplitude below the threshold voltage for reducing the remnant DC voltages according to an exemplary embodiment of the invention, and (c) illustrates an example of the implementation of the present invention, in which the low voltage de-balancing pulse has an opposite polarity to the driving pulse; and

FIG. 6 illustrates part of a typical random greyscale transition sequence using a voltage modulated transition matrix with more practical greyscale transitions: two successive transitions with the same polarity (transitions n+1 followed by n+2), whereby a low voltage de-balancing pulse is used which has an opposite polarity to the driving pulse.

Preferably, the (voltage)×(time) product in the area Bₙ₊₂ should be equal to the area Aₙ₊₂ if all of the transitions before n+2 transition are perfectly de-balanced.

FIGS. 1 and 2 illustrate an exemplary embodiment of a display panel 1 having a first substrate 8, a second opposed substrate 9, and a plurality of picture elements 2. In one embodiment, the picture elements 2 might be arranged along substantially straight lines in a two-dimensional structure. In another embodiment, the picture elements 2 might be arranged in a honeycomb arrangement. In an active matrix embodiment, the picture elements may further comprise switching electronics, for example, thin film transistors (TFTs), diodes, MIM devices or the like.

An electrophoretic medium 5, having charged particles 6 in a fluid, is present between the substrates 8, 9. A first and second electrode 3, 4 are associated with each picture element 2 for receiving a potential difference. In the arrangement illustrated in FIG. 2, the first substrate 8 has for each picture element 2 a first electrode 3, and the second substrate 9 has for each picture element 2 a second electrode 4. The charged particles 6 are able to occupy extreme positions near the electrodes 3, 4, and intermediate positions between the electrodes 3, 4. Each picture element 2 has an appearance determined by the position of the charged particles between the electrodes 3, 4.

Electrophoretic media are known per se from, for example, U.S. Pat. No. 5,961,804, U.S. Pat. No. 6,120,839 and U.S. 6,130,774, and can be obtained from, for example, E Ink Corporation. As an example, the electrophoretic medium 5 might comprise negatively charged black particles 6 in a white fluid. When the charged particles 6 are in a first extreme position, i.e. near the first electrode 3, as a result of potential difference applied to the electrodes 3, 4 of, for example, 15 Volts, the appearance of the picture element 2 is for example, white in the case that the picture element 2 is observed from the side of the second substrate 9.

When the charged particles 6 are in a second extreme position, i.e. near the second electrode 4, as a result of a potential difference applied to the electrodes 3, 4 of, for example, −15 Volts, the appearance of the picture element is black. When the charged particles 6 are in one of the intermediate positions, i.e. between the electrodes 3, 4, the picture element 2 has one of a plurality of intermediate appearances, for example, light grey, mid-grey and dark grey, which are grey levels between black and white.

Referring to FIG. 3 of the drawings, a schematic block diagram of an exemplary implementation of apparatus according to the invention is illustrated. The drive means 100 comprises a controller 102 for applying potential differences or pulses to the picture elements of the display 1, and a frame memory 104. A temperature sensor 106 is also provided.

As the display 1 is addressed, for each pixel, the product of the voltage and duration is read from the controller 102. After one or more image update periods, there will be a history generated of the total energy (or stress), i.e. voltage×time, seen by each picture element. Clearly, if in successive periods the polarity of the pixel voltage is reversed, the number in the memory 104 will be reduced, such that image retention will be reduced.

DC balancing is achieved by introducing a feedback loop into the controller 102 which attempts to reduce the number stored in the memory to zero by using the high voltage short pulses (or inter-picture potential differences) with a polarity opposite to the number stored in the memory. It will be appreciated therefore that the polarity of these high voltage short pulses are independent of the driving pulses.

As stated above, in this exemplary embodiment of the invention, the typical pulse duration is 2-8 ms, and the maximum voltage level available on the driver is preferred.

Referring to FIG. 4 of the drawings, a typical random greyscale transition sequence using a pulse width modulated transition matrix is shown. A high voltage short pulse is applied between t1 and t2 after the (n−1)th greyscale transition, for removing the remnant dc voltages from this transition. Two high voltage short pulses are applied between t3 and t4, after the (n)th greyscale transition, for removing the remnant dc voltages from this transition. In the example shown, the polarity of the dc-balancing pulses is the same as that of the driving pulse.

After the (n+1)th greyscale transition, two high voltage short pulses with the same polarity as the driving pulse are applied for removing the remnant dc voltages after this transition. The number and polarity of the dc-balancing pulses are stored in the memory, and are essentially independent of the driving pulses.

In another embodiment, a low voltage pulse may be applied to compensate for the remnant dc voltage. The amplitude of this low voltage pulse would such as to be insufficient to move the particles for a visible distance as measured by a change of optical state. This means that the amplitude of this low voltage pulse would ideally be below the threshold voltage of the ink materials used in the display. The time length and the voltage sign of this pulse are pre-determined according to the previous image history and stored in the memory.

FIG. 5(a) illustrates part of a typical random greyscale transition sequence using a voltage modulated transition matrix. Between the image state n and the image state n+1, there is always a certain time period available which may be anything from a few seconds to a few minutes, dependent on different users. When the display is driven to the image state n+1 from the state n, a pre-determined voltage Vₙ₊₁ is applied (available from the transition matrix look-up table). In the illustrated example, the driving pulse n has an opposite sign to the driving pulse n+1, which gives the minimum remnant dc voltages. Ideally, when the amplitude of both n and n+1 driving pulses is equal, this driving is then automatically dc balanced (since the pulse width is the same). However, the greyscale transitions in practical displays are completely random and thus the remnant dc voltages tend to appear on the pixel. It is necessary to timely remove these remnant de voltages.

FIG. 5(b) illustrates an improved driving scheme according to an exemplary embodiment of this invention, in which a low voltage pulse is added to the driving sequence immediately after the complete driving pulse. If desired, it is allowed to have a time period with zero voltage between the driving pulse and the dc-balancing pulse because the chosen low voltage of the dc-balancing pulse is only able to remove the remnant dc voltages on the pixel and is not able to change the optical performance, such that there is no visual effect.

The voltage sign of the dc-balancing pulse may also be opposite to that of the driving pulse as schematically shown in FIG. 5(c) after the transition to n state. Again, this is possible because the dc-balancing pulse does not have visual effect. It is apparent that the amplitude of the dc-balancing pulse should be sufficiently small to avoid the particles motion under the influence of this pulse. The voltage sign and pulse time length are determined by the previous actual greyscale transitions on the pixel using the (voltage)×(time) product principle described above. The voltage amplitude should be smaller than the switching threshold voltage for a specific ink material, usually below 1.0 V and the pulse time length is not limited, but tends to be between a few tens milliseconds to a few seconds depending on the image history.

FIG. 6 illustrates an example of two successive transitions with the same polarity (n+1, n+2). Clearly, such situation builds the most serve remnant dc voltage on the pixel after the n+2 transition is complete. The remnant dc voltage can only be removed by applying the low voltage dc-balancing pulse with an opposite voltage sign. It is obvious that the (voltage)×(time) product in the area Bₙ₊₂ should be equal to the area Anₙ₊₂ if all transitions before n+2 transition are perfectly dc-balanced. The corresponding pulse time length and voltage may be stored in a pre-determined matrix look-up-table, where the driving voltage Vₙ₊₂ and driving time are also located.

It will be appreciated that the present invention is also applicable to pulse-width modulation driving method or other pulse-shaping driving.

An embodiment of the present invention has been described above by way of example only, and it will be apparent to a person skilled in the art that modifications and variations can be made to the described embodiment without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A display apparatus (1) comprising:
an electrophoretic medium (5) comprising charged particles (6) in a fluid;
a plurality of picture elements (2);
a first and second electrode (8,9) associated with each picture element (2) for receiving a potential difference; and
drive means (100) arranged to:
a) supply a sequence of picture potential differences to each of said picture elements (2), each of said picture potential differences having a picture value and an associated picture duration, the product of which represents a picture energy for enabling the particles to occupy one of the positions for displaying a picture; and
b) supply one or more inter-picture potential differences between at least two consecutive picture potential differences, said one or more inter-picture potential differences having an inter-picture value and an associated inter-picture duration, the product of which represents an inter-picture energy which is insufficient to substantially change the positions of the particles;
the apparatus (1) further comprising memory means (104) for receiving data representative of the picture energy and inter-picture energy of all potential differences applied to each picture element (2), and providing a running total thereof for each picture element (2), the drive means (100) being arranged to select the polarity of said one or more inter-picture potential differences such that the magnitude of said running total for a respective picture element (2) is reduced.

2. Apparatus (1) according to claim 1, wherein a time interval is provided between each inter-picture potential difference applied to a picture element (2).

3. Apparatus (1) according to claim 2, wherein said time interval is of the order of 0.5.

4. Apparatus (1) according to any one of the preceding claims, wherein the pulse time-period of each inter-picture potential difference is 2-8 ms.

5. Apparatus (1) according to any one of the preceding claims, wherein the value of said inter-picture potential differences is substantially the maximum voltage available on the drive means (100).

6. Apparatus (1) according to any one of the preceding claims, wherein one or more of said inter-picture potential differences have an inter-picture value below the threshold voltage of the ink materials used in said display apparatus.

7. Apparatus (1) according to any one of the preceding claims, wherein the number and polarity of said inter-picture potential differences are stored in the memory means (104).
